(19) United States
(12) Patent Application Publication
(10) Pub. No.: US 2009/0218149 A1
(43) Pub. Date: Sep. 3, 2009

(54) Modular multi-purpose machine

(76) Inventor: Chien-Ho Ko, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,189

(22) Filed: Aug. 5, 2008

(30) Foreign Application Priority Data
Mar. 3, 2008 (TW) 97107363

(51) Int. Cl. B62D 39/00

(52) U.S. Cl. 180/65.1

(57) ABSTRACT

A modular multi-purpose machine includes a body, a chassis device, a height adjustment device and a modular apparatus. The body has an elongated hole. The chassis device is connected to the bottom of the body and comprises a movement device. The movement device is demountably connected to the bottom of the body and c includes a driving device and multiple moving members. The driving device is connected to the moving members. The height adjustment device is mounted in the body and comprises a first connection portion and an elevating device. The first connection portion is movably mounted and partially held in the elongated hole, and is connected to the elevating device. The modular apparatus includes a machine body and a second connection portion. The machine body is connected to the second connection portion and is demountably connected to the first connection portion.

### RELATED APPLICATIONS

This application claims priority to Taiwan Application Serial Number 97107363, filed Mar. 3, 2008, which is herein incorporated by reference.

### BACKGROUND

1. Field of The Invention

The present invention relates to a modular machine. More particularly, the present invention relates to a modular machine with a plurality of substitutable and different purpose apparatuses such as a marking apparatus, a rock-breaking machine, a cutting apparatus etc.

2. Description of Related Art

Conventional small construction machines such as road marking machines, rock-breaking machines and road cutters are single purpose machines. Therefore, single purpose machines are inconvenient when doing construction work because construction work often requires the completion of many different tasks. If the single purpose machine is used in construction work, many different machines must be used to complete the different construction tasks.

Further, most of the small engineering machines are hand held type. Some of them equipped with simple wheels to enable the machine working parts to move. Hand held type machines generally cause fatigue to the hand and may gradually harm the hands. Some machines however are moved on wheels. Construction sites generally have very bumpy or muddy surfaces severely inhibiting the mobility of the mobile machines.

Therefore, there is a need to provide an improved multiple-purpose machine to mitigate or obviate the aforementioned problems.

### SUMMARY

An object of the present invention is to provide a modular multi-purpose machine that has a modular apparatus, and the modular apparatus is substitutable with a specific function and is easy to substitute to provide different engineering function to improve convenience of construction.

An apparatus in accordance with the present invention includes a body, a control device, a power device, a chassis device, a height adjustment device and a modular apparatus. The body comprises an elongated hole and has a bottom. The control device is mounted on the body and comprises a controller. The power device comprises a power source and is electrically connected to the controller. The chassis device is connected to the bottom of the body and comprises a movement device, wherein the movement device is demountably connected to the bottom of the body and comprises a driving device and multiple moving members, and the driving device is connected to the moving members. The height adjustment device is mounted in the body and comprises a first connection portion and an elevating device. The first connection portion is movably mounted and partially held in the elongated hole and is connected to the elevating device. The modular apparatus comprises a machine body and a second connection portion, wherein the machine body is connected to the second connection portion and is electrically connected to the controller, the second connection portion is demountably connected to the first connection portion.

In an embodiment, the movement device is a track device, the driving device is a motor, and the moving members are vehicle tracks.

In an embodiment, the movement device is a wheel device, the driving device is a motor, and the moving members are wheels.

In an embodiment, the movement device is an omni-wheel device, the driving device is a motor, and the moving members are omni-wheels.

In an embodiment, the machine body is a marking apparatus, a rock-breaking apparatus or a cutting apparatus.

Therefore, the multi-purpose machine of the disclosed embodiment is suitable for various engineering tasks and is a convenient substitute for single multi-purpose machines including marking apparatus, rock-breaking apparatus and cutting apparatus etc. The controller controls the operations of the different machines using preinstalled control programs for the different machines. In addition, since the operation heights of the different machines are different, the operations of the elevating device can be controlled through the control panel and the buttons to lift or lower the elevating base of the elevating device through changing the rotation directions of the linear transmission members of the height adjustment device. The elevating base moves the connected first and second connection portions so that the entire modular apparatus can be lifted or lowered to adjust its height.

### BRIEF DESCRIPTION OF THE DRAWINGS

These and other features, aspects, and advantages of the present invention will become better understood with regard to the following description, appended claims, and accompanying drawings where:

FIG. 1 is a perspective view of an embodiment of a modular multi-purpose machine;

FIG. 2 is a perspective view of a first embodiment of a movement device of the multi-purpose machine in FIG. 1;

FIG. 3 is a perspective view of a second embodiment of a movement device of the multi-purpose machine in FIG. 1;

FIG. 4 is a perspective view of a third embodiment of a movement device of the multi-purpose machine in FIG. 1;

FIG. 5 is a section view of a height adjustment device of the multi-purpose machine in FIG. 1;

FIG. 6 is a perspective view of an embodiment of a modular apparatus of the multi-purpose machine in FIG. 1 wherein the modular apparatus is a marking apparatus; and

FIG. 7 is a perspective view of an embodiment of a modular apparatus of the multi-purpose machine in FIG. 1 wherein the modular apparatus is a cutting apparatus.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

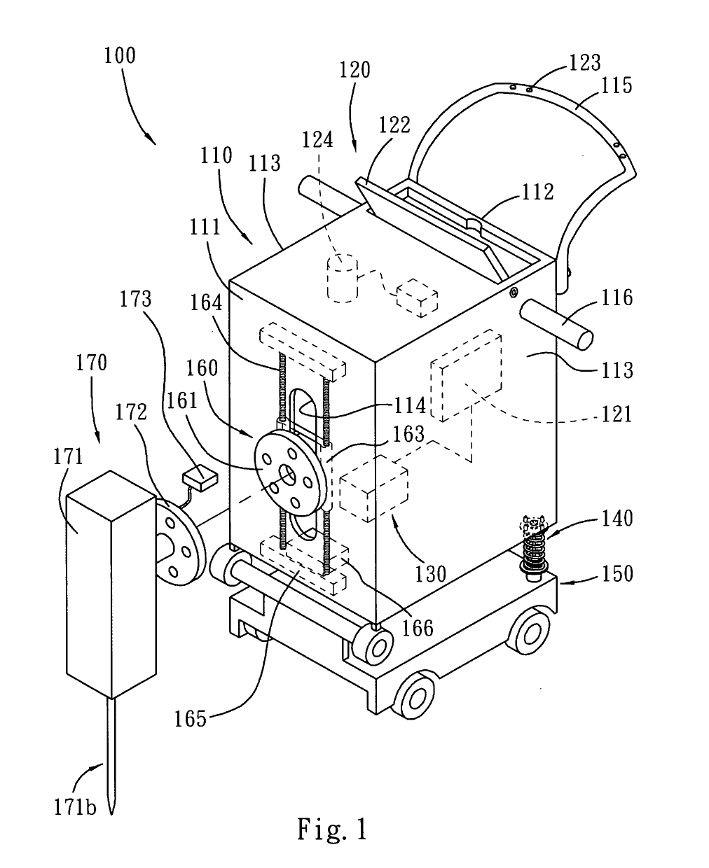

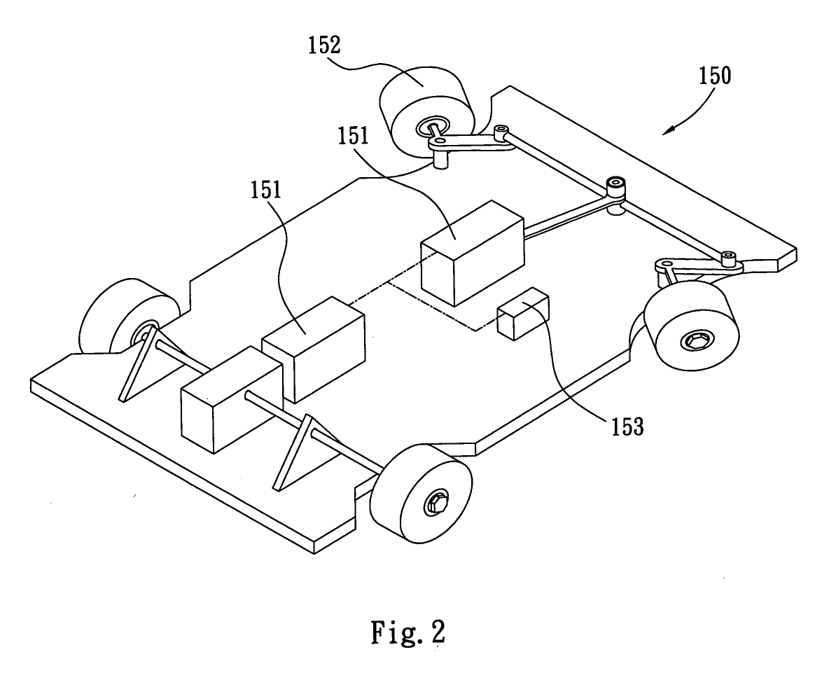

Refer to FIG. 1 and FIG. 2. An embodiment of a modular multi-purpose machine 100 comprises a body 110, a control device 120, a power device 130, a chassis device, a height adjustment device 160 and a modular apparatus 170.

The body 110 has a front 111, a rear 112 and two sides 113. The body 110 comprises an elongated hole 114 defined in the front 111, a pushing rod 115 mounted on the rear 112 and two handles 116 mounted respectively at the sides 113.

The control device 120 is mounted on the body 110 and comprises a controller 121, a controlling panel 122, one or more than one button 123 and a positioning device 124. The controller 121 is mounted in the body 110 and is a programmable controller. The controller 121 may have preinstalled controlling programs saved therein that respectively control different modular apparatuses 170. The controlling panel 122 may be a touch panel, is electronically connected to the controller 121 and is mounted in the body 110 such as the top of the body 110. In addition, the controlling panel 122 may be pivotally mounted on the body 110 so that the controlling panel 122 can be pivoted to a given angle relative to the body 110 to conveniently view or input data. The buttons 123 are electrically connected to the controller 121 and are mounted on the pushing rod 115 for conveniently being pressed to operate the machine. The positioning device 124 is electrically connected to the controller 121 and may be a digital compass module. The digital compass module cooperates with two reference points outside the modular multi-purpose machine 100 to enable moving the modular multi-purpose machine 100 along a given path.

The power device 130 comprises a power source and is electrically connected to the controller 121 to provide electricity for other electronic components of the modular multi-purpose machine 100 through the controller 121.

The chassis device is connected to the bottom of the body 110 and comprises a shock absorbing device 140 and a movement device 150. The movement device 150 is demountably connected to the bottom of the body 110. Demountable fastening members such as bolts can be used to fasten the chassis device and the body 110. Thus, the movement device 150 is conveniently substituted with different types. The shock absorbing device 140 is mounted between the bottom of the body 110 and the movement device 150 and may comprise two shock absorbers to absorb and dissipate shocks or vibrations during operation or moving period.

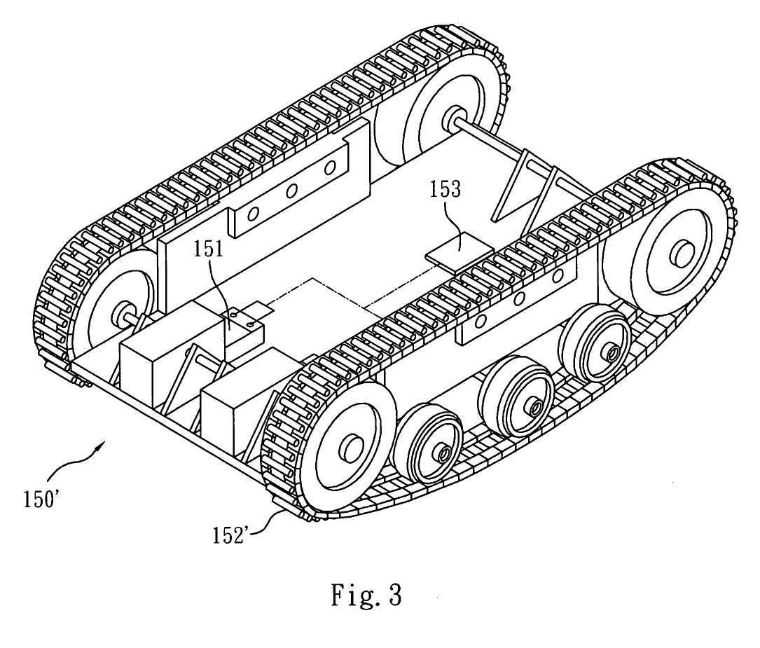

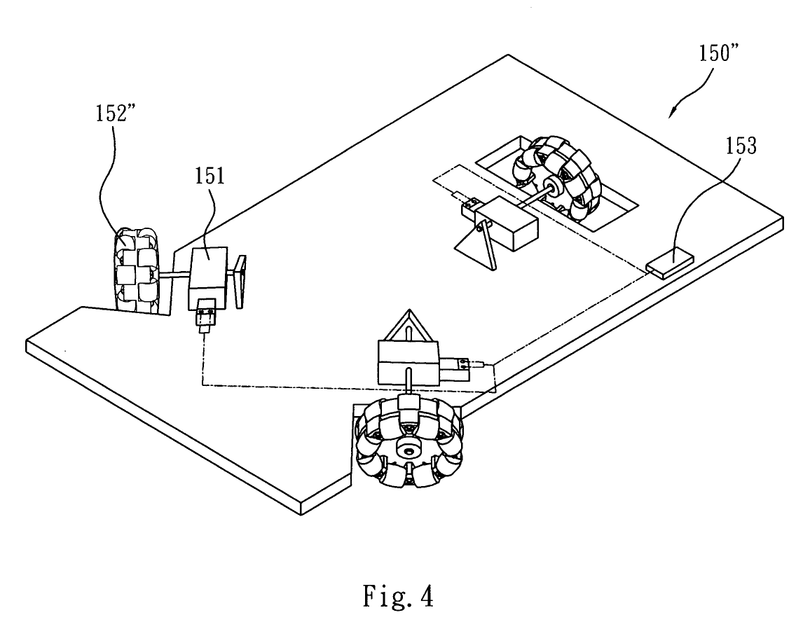

Refer to FIG. 3 and FIG. 4. The movement device 150 may be a different type of wheel device or band device. The movement device 150 may be a track device as shown in FIG. 3, a wheel device as shown in FIG. 2, an omni-wheel device as shown in FIG. 4. The movement device 150 supports the body 110 so that the whole modular multi-purpose machine 100 can move on a surface such as the ground. The movement device 150 comprises a driving device 151 and multiple moving members 152. The driving device 151 may be servo motors and is electrically connected to the controller 121 so that the controller 121 controls the driving device 151 to drive the moving members 152. A connector 153 may connect the driving device 151 and the controller 121. When the movement device 150 is a wheel device, the moving members 152 are wheels. When the movement device 150′ is a track device, the moving members 152′ are vehicle tracks. When the movement device 150″ is an omni-wheel device, the moving members 152″ are omni-wheel. Thus, the movement device 150 is substitutable to be able to meet different terrain conditions.

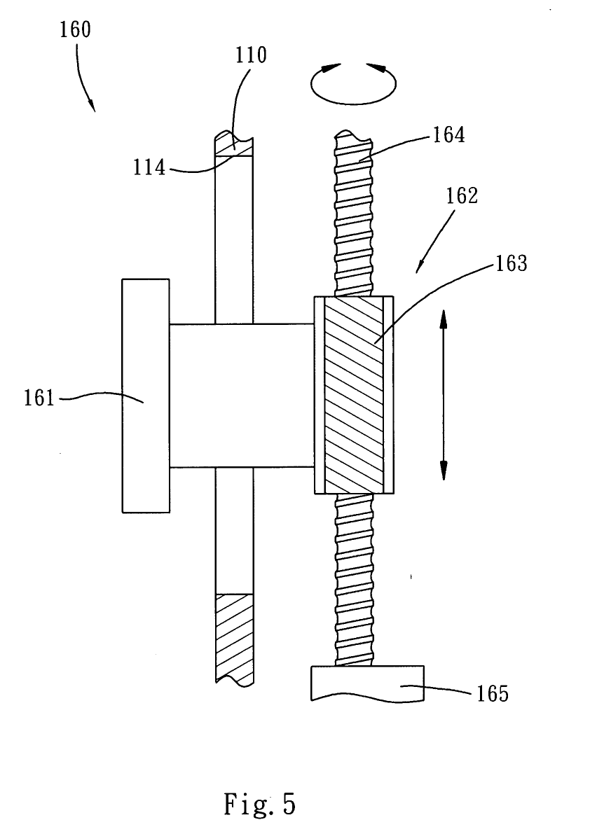

Refer to FIG. 5. The height adjustment device 160 is mounted in the body 110 and comprises a first connection portion 161 and an elevating device 162. The first connection portion 161 may be a flange, is movably mounted and partially held in the elongated hole 114, and is connected to the elevating device 162 so that the elevating device 162 moves upwardly and downwardly the first connection portion 161 along the elongated hole 114.

The elevating device 162 comprises an elevating base 163, two linear transmission members 164, a reducing device 165 and a motor 166. The linear transmission members 164 may be lead screws and are located alongside the elongated hole 114. Changing the rotating direction and revolution speed of the linear transmission members 164 adjusts the height of the elevating base 163. The linear transmission members 164 are coupled to the reducing device 165. The reducing device 165 is connected to the motor 166. Thus, the motor 166 can rotate the linear transmission members 164 by the reducing device 165 to adjust the height of the elevating base 163 i.e. the height of the first connection portion 161. The motor is electrically connected to the controller 121 and is controlled by the controller 121.

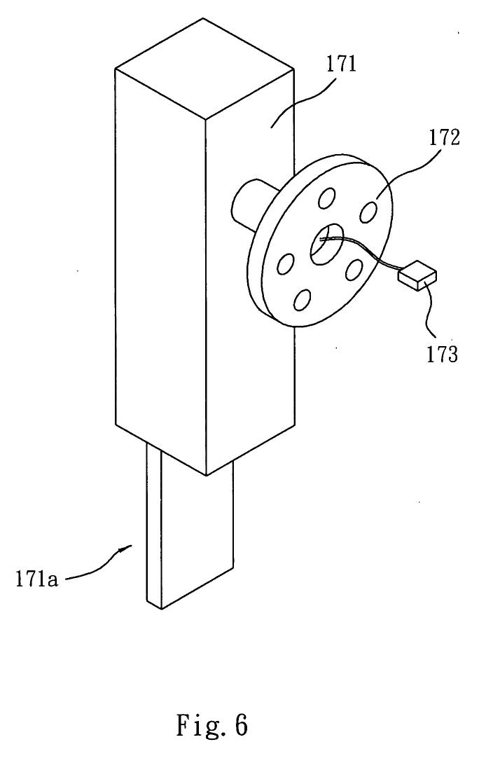

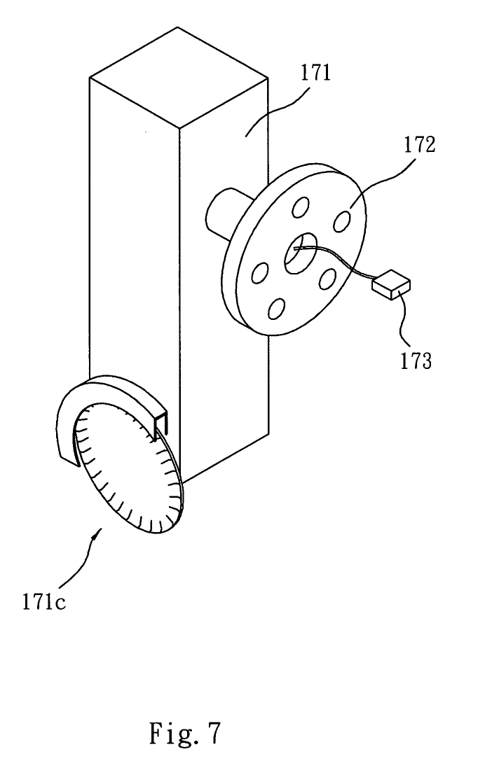

Refer to FIG. 1, FIG. 6 and FIG. 7. The modular apparatus 170 may be substituted with different functions based on the practical demands and comprises a machine body 171 and a second connection portion 172. The machine body 171 may be a marking apparatus 171a, a rock-breaking machine 171b, a cutting apparatus 171c etc. and is electrically connected to the controller 121 through a connector 173 so that the controller 121 controls the operations of the modular apparatus 170. The second connection portion 172 is connected to the machine body 171 and may be a flange. The second connection portion 172 is demountably connected to the first connection portion 161 through fasteners such as nuts and bolts that secure them firmly together. When the different machine body 171 is needed to substitute, the second connection portion 172 and the first connection portion 161 provide quickly and conveniently demounting and mounting operations to substitute the modular apparatus 170.

Therefore, for various engineering demands, the multi-purpose machine 100 provides convenient substitution of the machine body 171, such as the marking apparatus 171a, the rock-breaking apparatus 171b, the cutting apparatus 171c etc. The controller 121 controls the operations of the different machines 171a,171b and 171c by the previously stored control programs for the different machines 171a,171b and 171c. In addition, since the operation heights of the different machines 171a,171b and 171c are different, the operations of the elevating device 162 can be controlled through the control panel 122 and the buttons 123 to lift or lower the elevating base 130 through changing the rotation directions of the linear transmission members 164. The elevating base 163 moves the connected first and second connection portions 161,172 so that the entire modular apparatus 170 can be lifted or lowered to adjust its height.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A modular multi-purpose machine comprising:
a body comprising an elongated hole and having a bottom;
a control device mounted on the body and comprising a controller;
a power device comprising a power source and electrically connected to the controller;
a chassis device connected to the bottom of the body and comprising a movement device, wherein the movement device is demountably connected to the bottom of the body and comprises a driving device and multiple moving members, and the driving device is connected to the moving members;
a height adjustment device mounted in the body and comprising a first connection portion and an elevating device, the first connection portion movably mounted and partially held in the elongated hole and connected to the elevating device; and
a modular apparatus comprising a machine body and a second connection portion, wherein the machine body is connected to the second connection portion and is electrically connected to the controller, the second connection portion is demountably connected to the first connection portion.

2. The modular multi-purpose machine as claimed in claim 1, wherein the body further has a front, a rear and two sides and further comprises a pushing rod mounted on the rear and two handles mounted respectively at the sides wherein the elongated hole is defined in the front.

3. The modular multi-purpose machine as claimed in claim 2, wherein the control device further comprises:
a control panel electronically connected to the controller and mounted pivotally on the body; and
at least one buttons electronically connected to the controller and mounted on the pushing rod.

4. The modular multi-purpose machine as claimed in claim 3, wherein the control device further comprises a positioning device mounted on the body and electrically connected to the controller.

5. The modular multi-purpose machine as claimed in claim 4, wherein the controller is a programmable controller, the control panel is a touch panel and the positioning device a digital compass module.

6. The modular multi-purpose machine as claimed in claim 1, wherein the chassis device further comprises a shock absorbing device mounted between the bottom of the body and the movement device.

7. The modular multi-purpose machine as claimed in claim 1, wherein the movement device is a track device, the driving device is a motor and the moving members are vehicle tracks.

8. The modular multi-purpose machine as claimed in claim 1, wherein the movement device is a wheel device, the driving device is a motor and the moving members are wheels.

9. The modular multi-purpose machine as claimed in claim 1, wherein the movement device is an omni-wheel device, the driving device is a motor and the moving members are omni-wheels.

10. The modular multi-purpose machine as claimed in claim 1, wherein the elevating device comprises:
two linear transmission members mounted in the body and located alongside the elongated hole;
an elevating base mounted adjustably between the linear transmission members;
a reducing device coupled to the linear transmission members; and
a motor connected to the reducing device and is electrically connected to the controller.

11. The modular multi-purpose machine as claimed in claim 10, wherein the first connection portion is a flange, the second connection portion is a flange, and the linear transmission members are lead screws.

12. The modular multi-purpose machine as claimed in claim 1, wherein the machine body is a marking apparatus.

13. The modular multi-purpose machine as claimed in claim 1, wherein the machine body is a rock-breaking apparatus.

14. The modular multi-purpose machine as claimed in claim 1, wherein the machine body is a cutting apparatus.
